(19) United States
(12) Patent Application Publication
(10) Pub. No.: US 2006/0048341 A1
(43) Pub. Date: Mar. 9, 2006

(54) Jog shuttle knob

(76) Inventors: Thomas John Koller, West Linn, OR (US); Tok Doun, Beaverton, OR (US); Matthew Albert Ivey, Portland, OR (US)

Correspondence Address: THOMSON LICENSING INC., PATENT OPERATIONS, PO BOX 5312, PRINCETON, NJ, 08543-5312, US

(21) Appl. No.: 10/544,750

(22) PCT Filed: Oct. 29, 2003
(86) PCT No.: PCT/US03/34330

§ 371 Date: Aug. 8, 2005

(51) Int. Cl. E05B 1/00

(52) U.S. Cl. 16/413

(57) ABSTRACT

A control knob controls jog/shuttle operations on an audio/video payback/record device. The knob is formed of a cylindrical body having an outer portion and a face portion that has convex and concave regions, respectively, integral with each other. The convex region lies centered within, and surrounded by the concave region and with the two regions joined with a smooth radius transition. The smooth radius transition creates a topology that allows manipulation of the knob with only a small frictional force by a single finger of a user (not shown), thus allowing precisely rotation of knob to enter a jog mode at any angular position of the finger.

### TECHNICAL FIELD

The present invention relates to a knob, in particularly an operating knob suitable for precision rotation at variable rates.

### BACKGROUND ART

Present day professional audio and video playback devices typically have a jog/shuttle capability that allows an operator to advance or reverse the playback medium, either incrementally, (by a jog operation), or by more than an incremental amount (i.e., a shuttle operation), thereby allowing cueing of a particular segment for subsequent recording or playback. To that end, such playback devices have a jog/shuttle knob, which the operator rotates to jog or shuttle the playback medium.

A typical jog/shuttle knob engages the user's fingers and thumb, thereby enabling the user to rotate the knob. With present day jog/shuttles knobs, the user's thumb must lie parallel to the other four fingers to make fine adjustments. Such an orientation of the thumb and fingers becomes tiring, making continuous movement of the knob cumbersome.

To overcome this difficulty, some video and audio devices utilize a spinner-type jog/shuttle knob. In practice, such spinner knobs feature a polished finger spinner, taking the form of a single indentation near the edge of the knob face. This indentation accommodates rotation of the knob by a single finger, allowing the other fingers and the thumb to relax while a combination of wrist and finger motion rotate the knob. An example of a spinner type of jog/shuttle knob is the model PT-FD-20 knob manufactured by Rogan Corporation, Northbrook, Ill. While such polished finger spinner knobs are well designed for jog mode operation, they suffer from the disadvantage that the singular location of the polished finger inhibits transitions between three common modes of manipulation: (1) segment-by-segment playback, (2) attentive jogging through several segments, and (2) rapid shuttling through many segments. The singular location of the polished finger requires the user's fingers to search for the indentation when beginning the jog mode. Some

Some manufacturers of professional record and playback devices have sought to offer a jog shuttle capability by providing removable or replaceable disks/clutches that allow the user to toggle between the jog and shuttle modes by pushing the knob face. Such solutions are expensive and complicated.

Thus, there is need for an improved operating knob that overcomes the disadvantages of the prior art.

### BRIEF SUMMARY OF THE INVENTION

Briefly, in accordance with a preferred embodiment, there is provided a control knob, and more particularly, a jog/shuttle knob for use on an audio or video playback device. The knob comprises a substantially cylindrical body; having an outer portion whose perimeter has ribs positioned in a spaced relationship parallel to the axis of knob rotation. The body has a face portion with convex region centered within a concave region. The convex and concave regions of the face portion are integrally connected with a smooth radius transition. At least one ballast weight lies within the cylindrical body to provide the knob with increased mass to provide the user with greater control.

The knob of the present principles advantageously permits precision rotation by allowing multiple fingers to engage the outside circumference of the knob, thereby enabling a single finger jog operation upon friction manipulation of the concave and convex portions on the face of the knob. In addition, the knob allows users the do an “outside finger roll” and transition from precise to rapid sequence shuttling without straining the user's fingers.

### BRIEF DESCRIPTION OF THE DRAWINGS

FIG. 1 is a side view of the knob in accordance with the preferred embodiment of the present principles

FIG. 2 is a face view of the knob of FIG. 1; and

FIG. 3 is a cross sectional view of the knob of FIG. 1

### DETAILED DESCRIPTION OF THE INVENTION

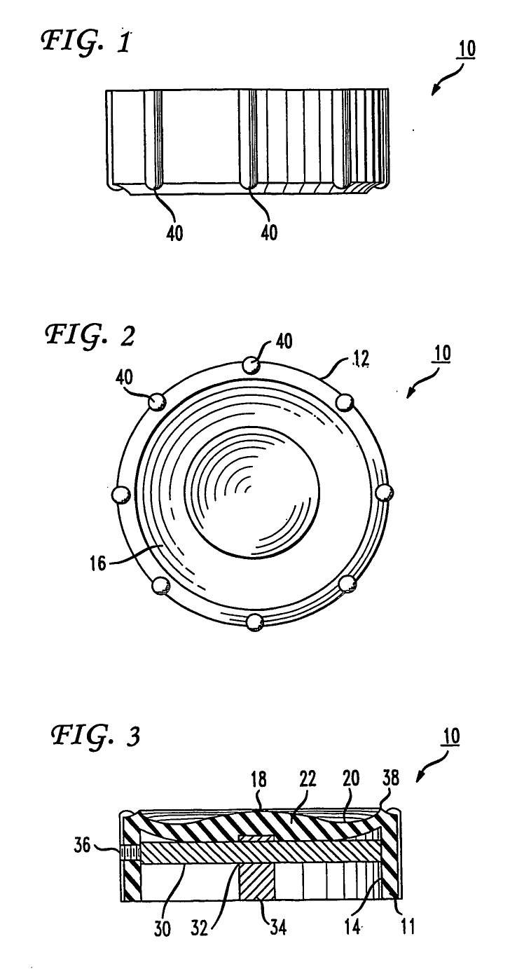

FIGS. 1-3 collectively illustrate a high-precision knob 10 in accordance with the present principles for use on an apparatus (not shown) such as an audio/video record/playback device, and preferably for controlling a jog/shuttle operation. The knob 10 comprises a hollow cylindrical body 11 having an exterior portion 12, an interior portion 14 and a face portion 16 at the top of the body. The body 11 is typically manufactured from rubber, and preferably, from Sanaoprene rubber having 73 durometer. Such material provides a smooth, comfortable feel and long-term durability.

As best seen in FIG. 3, the face portion 16 has convex and concave regions 18 and 20, respectively, integral with each other. The convex region 18 lies centered within, and surrounded by the concave region 20 and with the two regions joined with a smooth radius transition 22. The smooth radius transition 22 between the convex and concave regions 18 and 20, respectively, creates a topology that allows the knob 10 to be manipulated with only a small frictional force by a single finger of the user (not shown). Such a topology enables a user to precisely rotate the knob lo to enter a jog mode at any angular position of the finger and eliminates the need for the user's fingers to search for a polished indentation. In an alternative embodiment (not shown), the face portion 16 may have a friction enhancing texture for engaging the user's finger.

The inner portion 14 of the body 11 contains a cylindrical ballast 30, typically made from an individual metal (e.g., aluminum), or a metal alloy such as brass. The ballast 30 has a diameter on the order of the diameter of the inner portion 14 to assure a tight frictional engagement therebetween. The ballast 30 has a central opening 32 for receiving a shaft 34 rotated by the knob 10. A setscrew 36 extends through an opening in the body 11 and through the ballast 30 perpendicular to the axis of the shaft 34 to secure the shaft to the ballast. The ballast 30 serves to increases the mass of the knob 10, and thereby increases the inertia required to rotate the knob.

At the juncture between outer portion 12 and the face portion 16 lies an outer ring 38. The outer ring 38 of the exemplary embodiment has a 30° degree bevel for comfort. The outer portion 12 carries a plurality of ribs 40 in spaced relationship, each parallel to the axis of the shaft 34. The ribs 40, typically positioned at 45° increments about the periphery of the outer portion 12, increase finger tactile feedback.

In operation, a user controls a video/audio device through by rotating the knob 10 while the knob position undergoes monitoring via a non-linear sensing system (not shown). The sensing system can comprise a varistor, shaft encoder, or a similar mechanism to sense the angular position and rate of rotation of shaft 34, and hence the knob 10. When employed on a video record/playback device (not shown) having jog/shuttle capability, the knob 10, when rotated slowly, will cause the video record/playback device to jog video frames in proportion to the angular displacement of the knob, thereby facilitating very precise queuing of video frames. When the user spins the knob with enough force such that the angular momentum of the knob overcomes the stopping friction, the video record/playback device will shuttle frames at a more rapid rate.

The foregoing describes a jog/shuttle knob for precision rotation at variable rates.

1. A knob comprising:
a substantially cylindrical body having an outer portion and a face portion with a convex region centered within a concave region, said concave and convex regions being integrally connected; and
at least one ballast situated within said cylindrical body.

2. The knob according to claim 1 wherein the concave and convex regions are integrally connected by a smooth radius transition.

3. The knob according to claim 1 wherein the body is formed of rubber.

4. The know according to claim 3 wherein said body comprises Sanaoprene rubber having a 73 durometer.

5. The knob in claim 1 wherein according to claim wherein ballast comprises one of a metal and metal alloy.

6. The knob according to claim 5 wherein the ballast comprises one of aluminum and brass.

7. The control knob in claim 1 wherein the outer portion has a ring circumscribing the face and beveled at thirty degrees.

8. The control knob in claim 1 further comprising a plurality of ribs running along the outer portion in spaced relationship.

9. The control knob according to claim 8 wherein the ribs are spaced at forty-five degree increments about the perimeter of the outer portion.
